(19) United States
(12) Patent Application Publication
(10) Pub. No.: US 2015/0100998 A1
(43) Pub. Date: Apr. 9, 2015

(54) TV CLIP RECORD AND SHARE

(71) Applicants: Angelo J. Pino, JR., New York, NY (US); Mohammed Sattar, Bell Harbor, NY (US)

(72) Inventors: Angelo J. Pino, JR., New York, NY (US); Mohammed Sattar, Bell Harbor, NY (US)

(21) Appl. No.: 14/508,246

(22) Filed: Oct. 7, 2014

Related U.S. Application Data
(60) Provisional application No. 61/887,481, filed on Oct. 7, 2013.

(51) Int. Cl. H04N 21/858; H04N 21/4788; H04N 21/63; H04N 21/643; H04N 21/61; H04N 21/81; H04N 21/4147; H04N 21/472

(52) U.S. Cl. CPC H04N 21/8586; H04N 21/4147; H04N 21/4788; H04N 21/47217; H04N 21/64322; H04N 21/6175; H04N 21/812; H04N 21/632
USPC 725/112

(57) ABSTRACT

A system and method to share TV programming content that enables recording and sharing of video clips of TV programming, where viewer creates a recording/video clip, which can then be shared via a link of the video clip.

### FIELD OF THE INVENTION

The present invention generally relates to recording and sharing of television programming content in the form of a video clip made accessible to other users by clicking a link. The broadcasting service, or original content programmer, can insert ads and show related links to full episodes or promote new content, and also collect data and statistics of usage and viewing.

### BACKGROUND OF THE INVENTION

Set-top boxes connect televisions and other displays to external sources of video content. Many interactive set-top boxes allow users to choose to view one of a plurality of video content units (e.g. movies, television programs, etc.). Current television providers allow users to select and record desired video content of digital video recorders. However, there is no way to share saved video content with other users.

### SUMMARY OF THE INVENTION

An objective of the invention is to provide a method that could be used by content viewers to record and share segments of the viewed video content that they find relevant or interesting and allowing other users to view and further share the recorded video content.

This objective and other objectives can be obtained by a system, method and device for providing the capability to record segments of TV programming from video content viewed on a television and received from a television service provider, through a set-top box (DVR or Cloud DVR). While viewing TV programming, the user can select the start time of the recording by using the interface designed specifically for this task. The recording can be programmed to be a preset length in time which would be previously selected in the recording preferences (e.g. 1 min, 2 mins etc.) or can be stopped as per the user's specific preference. Once the recording is completed, the user interface can prompt the user to select an option for sharing the recorded video content. The system will generate a link that will be included and sent to the chosen option. The recording and sharing interface will disappear from the screen so the user can return to viewing the programming of their choice.

Broadcasters and content programmers can insert advertising and promotional material with this shared recording link as well as track usage and collect relevant data and statistics.

### BRIEF DESCRIPTION OF THE DRAWINGS

FIG. 1 is a diagram illustrating the interaction of the remote control (2) with the set top box (4), and cloud DVR (8) as well as the interaction of the mobile device (10) with the set top box (4), internet (14) and cloud DVR (8).

FIG. 2 is a flowchart detailing the process by which the user will record (20, 22, 24), generate (26, 28, 30) and share the recorded clip (32, 34, 36) and content provider/broadcaster will include ads and collect relevant usage data (38).

### DETAILED DESCRIPTION OF THE INVENTION

In the following description, for purposes of explanation and not limitation, specific details are set forth, such as particular networks, communication systems, computers, terminals, devices, components, techniques, data and network protocols, software products and systems, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, computers, terminals, devices, components, techniques, data and network protocols, software products and systems, operating systems, development interfaces, and hardware are omitted so as not to obscure the description.

As used herein, the term video content includes, but is not limited to, movies, television programs (e.g., a sitcom, a comedy, an infomercial, a commercial, a documentary, news programming), a sporting event, etc.—any of which can comprise video on demand, pay per view, and a live (when possible) or a recorded content. In addition, such content may comprise multiple segments between which the broadcaster may insert other content units (e.g., commercials and/or news alerts).

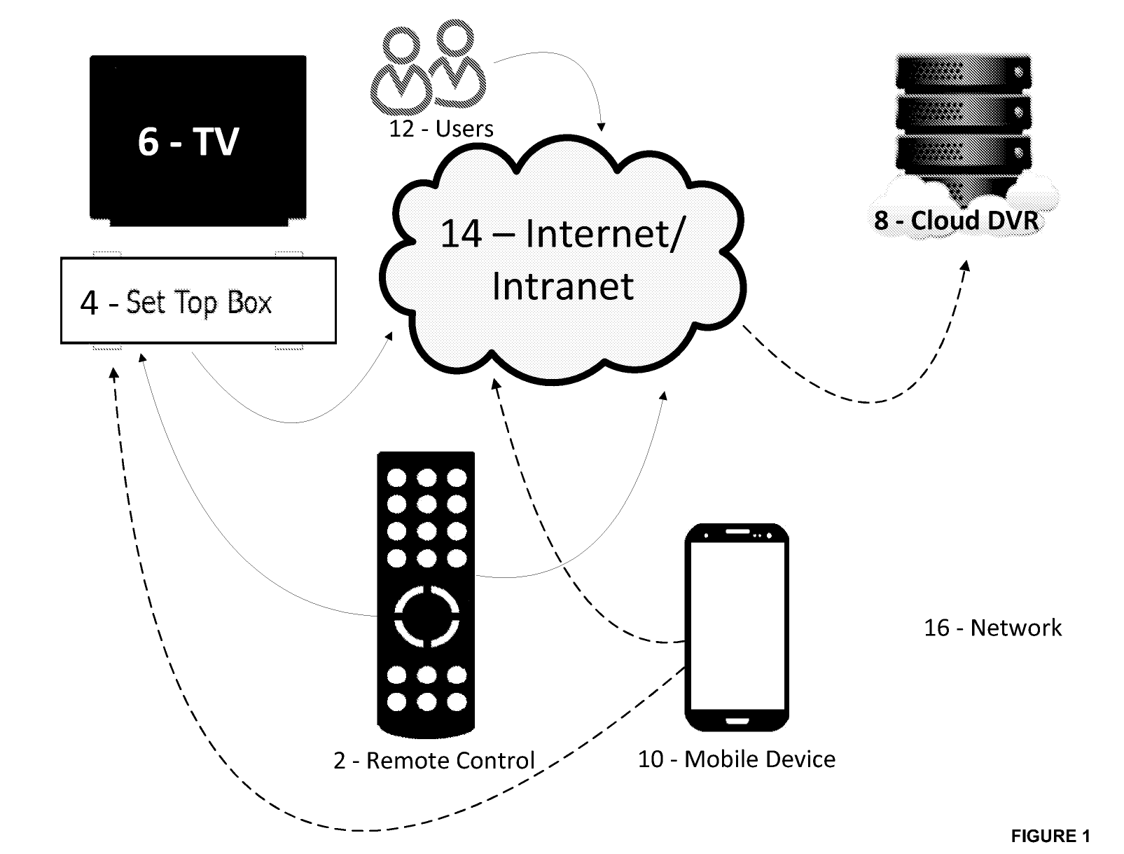

FIG. 1 illustrates a system for practicing embodiments of the present invention. FIG. 1 illustrates the interaction of the remote control 2 with the set top box 4, and cloud digital video recorder (DVR) 8 as well as the interaction of the mobile device 10 with the set top box 4, internet 14 and cloud DVR 8. Additional users 12 can access the DVR 8 through the internet 14. The mobile device 10 can be any mobile device capable of connecting to the internet and playing video content, for example, but not limited to a smartphone or tablet. The cloud DVR 8 can be located anywhere as desired and is connected to the internet 14. The set top box 4 is connected to a television 6 and to the internet 14. The set top box 4 can comprise a stand along device, a circuit card configured to be inserted into a television, or be integrated into the television 6. The mobile device 10 can have display for displaying recorded video content. Not all embodiments need to make use of the Internet 14 and instead may include a local or private network, or telephone network 16. The cloud DVR 8 can include a computer system for hosting a website and user information. Alternatively, a separate computer system can be used to host a website.

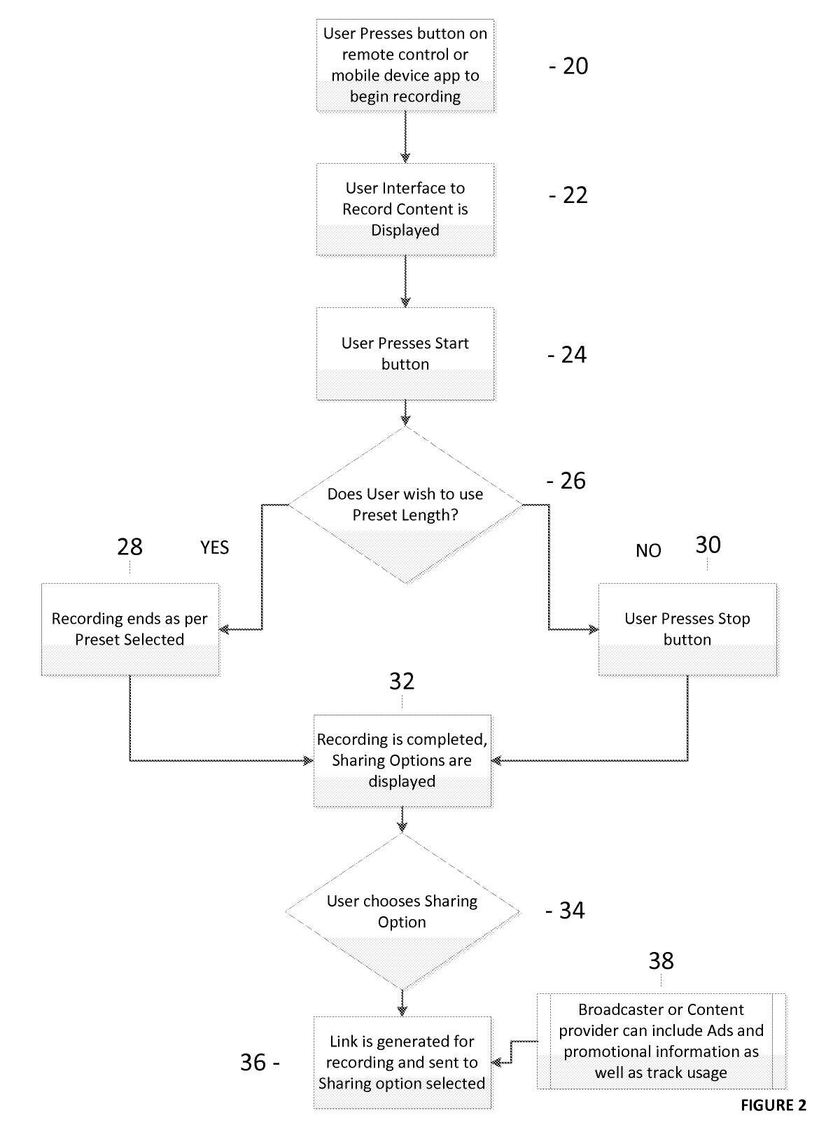

An exemplary use of the system is illustrated in FIG. 2. As shown at 20, the user can initiate the process by using the remote control 2 or mobile device 10 to create a video clip from the set top box 4 (which can have a DVR). The timing of the clip can be pre-determined or user determined, or limited by an application. An application can provide preset clip lengths for the user to select so that the provider of the content wants to limit the length of the clip that can be shared.

The user interface (the television or display on the mobile device) informs the user of video content 22. The user can select desired video content and initiate the start of the recording 24. The user is prompted with a question as to whether a preset record time is desired 26. If no, the user can press stop button at the desired end or enter a desired amount of time 30. If yes, the recording ends at the pre-set time 28. Once the recording is completed, sharing options for the saved video clip are displayed to the user 32. The user chooses a sharing option 34. A link is generated for the saved video clip sent to sharing option selected by user 36. A broadcaster or content provider can include Ads, promotional information, or other information and track usage to the video clip 38. Users 12 can access the saved video clip by accessing the link. The link can be sent to the other users 12 via a sharing or social application, such as facebook, or any other method, such as email or messaging. In a preferred embodiment, both the set top box and cloud DVR are where the clip is created from. The clip's storage and link distribution can be handled by another server on the cable network intranet (cable headend) or any server on the internet.

The operations described in Figs. and herein can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

The server and/or DVR described herein can include one or more computer systems directly connected to one another and/or connected over a network. Each computer system includes a processor, non-transitory tangible memory, user input and user output mechanisms, a network interface, and executable program code (software) comprising computer executable instructions stored in non-transitory tangible memory that executes to control the operation of the server. Similarly, the processors functional components formed of one or more modules of program code executing on one or more computers. Various commercially available computer systems and operating system software can be used to implement the hardware and software. The components of each server can be co-located or distributed. In addition, all or portions of the same software and/or hardware can be used to implement two or more of the functional servers (or processors) shown. The server can run any desired operating system, such as Windows, Mac OS X, Solaris or any other server based operating systems.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, s and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

1. A method of recording and sharing video content with users comprising:
recording video content by a user onto a cloud-based digital video recorder;
preparing a link to the recorded video content on the cloud-based digital video recorder; and
using the link by a second user to view the recorded video content.

2. The method according to claim 1, further comprising adding an advertisement to the recorded video content being viewed by the second user.

3. A system for recording and sharing video content comprising:
a set-top box connected to the internet;
a cloud-based digital video recorder connected to the internet configured to generate a link to a recorded video content stored on the recorder, and users connected to the internet can use the link to view the recorded video content.

4. The system according to claim 2, further comprising an advertisement linked to the recorded video content.
